(19) United States
(12) Patent Application Publication
(10) Pub. No.: US 2023/0384480 A1
(43) Pub. Date: Nov. 30, 2023

(54) SYMMETRICAL METASURFACE OPTICAL DEVICE

(71) Applicant: Shphotonics Ltd, Suzhou (CN)

(72) Inventors: Lei SUN, Suzhou (CN); Bing QIU, Suzhou (CN)

(21) Appl. No.: 18/320,314

(22) Filed: May 19, 2023

(30) Foreign Application Priority Data
May 25, 2022 (CN) 202210579614.4

(51) Int. Cl. G02B 1/00; G02B 3/08

(52) U.S. Cl. CPC G02B 1/002; G02B 3/08; G02B 2207/101; G02B 2003/0093

(57) ABSTRACT

A symmetrical metasurface optical device includes a substrate and a plurality of nanopillars symmetrically arranged at a surface of the substrate. The plurality of nanopillars have different optical properties. When a center of symmetry of the plurality of nanopillars coincides with a center of the substrate, nanopillars of a same optical property among the plurality of nanopillars are distributed non-uniformly and symmetrically. Or when the nanopillars of the same optical property among the plurality of nanopillars are distributed uniformly and symmetrically, the center of symmetry of the plurality of nanopillars does not coincide with the center of the substrate.

### CROSS-REFERENCE TO RELATED APPLICATION

This application claims priority to Chinese Application No. 202210579614.4, filed on May 25, 2022, the entire content of which is incorporated herein by reference.

### TECHNICAL FIELD

The present disclosure relates to the technical field of optics and, in particular, to an eccentrical symmetrical metasurface optical device.

### BACKGROUND

In the principle of imaging, an optical device (such as a lens) performs a series of processing on a light emitted by an object, and focuses the processed light to obtain an image of the object. However, it is difficult to achieve ideal optical processing properties (also referred to as optical properties) when the optical device is manufactured. As such, there is a difference between an image of the processed light and the original image of the object, which is called “aberration” in the field of optics. Aberrations include symmetric aberrations and asymmetrical aberrations.

Metasurface device is a type of optical device, and a metasurface structure refers to a type of optical material including nanopillars capable of achieving optical properties that cannot be achieved by conventional optical materials. In order to eliminate aberrations of the metasurface device or other optical devices in the system, a commonly used structure of the metasurface optical device is that various nanopillars of the metasurface optical device are arranged symmetrically based on polar coordinates, and a center of arrangement of the nanopillars coincides with a center of the metasurface optical device.

The symmetrical aberrations can often be eliminated by changing optical properties of an optical device in an axial direction of the optical device, while the asymmetrical aberrations need to be eliminated by changing optical properties in a direction perpendicular to the axial direction of the optical device. Using a nanopillar structure symmetrical in the polar coordinates as a symmetric optical waveguide only changes the optical properties in the axial direction but does not change the optical properties in the directions perpendicular to the axial direction. Therefore, the asymmetrical aberrations cannot be eliminated.

### SUMMARY

One aspect of the present disclosure provides a symmetrical metasurface optical device. The symmetrical metasurface optical device includes a substrate and a plurality of nanopillars symmetrically arranged at a surface of the substrate. The plurality of nanopillars have different optical properties. When a center of symmetry of the plurality of nanopillars coincides with a center of the substrate, nanopillars of a same optical property among the plurality of nanopillars are distributed non-uniformly and symmetrically. Or when the nanopillars of the same optical property among the plurality of nanopillars are distributed uniformly and symmetrically, the center of symmetry of the plurality of nanopillars does not coincide with the center of the substrate.

### BRIEF DESCRIPTION OF THE DRAWINGS

To more clearly illustrate the technical solutions in the present disclosure, the accompanying drawings used in the description of the disclosed embodiments are briefly described below. The drawings described below are merely some embodiments of the present disclosure. Other drawings may be derived from such drawings by a person with ordinary skill in the art without creative efforts and may be encompassed in the present disclosure.

FIG. 1 is a schematic structural diagram of an exemplary symmetrical metasurface optical device according to some embodiments of the present disclosure.

FIG. 2 is a schematic cross-sectional view of an exemplary metasurface structure according to some embodiments of the present disclosure.

FIG. 3 is a schematic diagram showing a periodic arrangement and distribution of nanopillars in polar coordinates according to some embodiments of the present disclosure.

FIG. 4 is a schematic diagram of a vortex distribution of nanopillars according to some embodiments of the present disclosure.

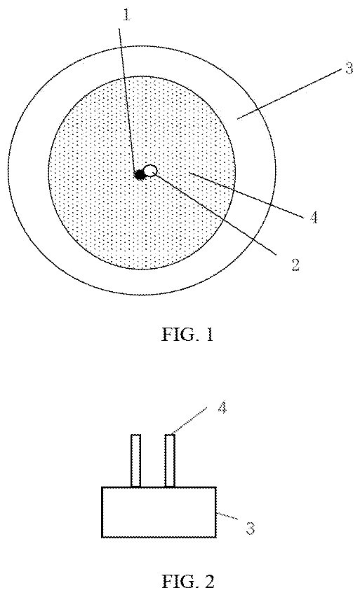

Components indicated by numerals in FIGS. 1 to 4 include: 1. center of substrate, 2. center of symmetry of a plurality of nanopillars, 3. substrate, 4. nanopillar, and 5. origin of polar coordinates.

### DETAILED DESCRIPTION OF THE EMBODIMENTS

In the following, some example embodiments are described. As those skilled in the art would recognize, the described embodiments can be modified in various different manners, all without departing from the spirit or scope of the present disclosure. Accordingly, the drawings and descriptions are illustrative in nature and not limiting.

In the present disclosure, terms such as “first,” “second,” and “third” can be used to describe various elements, components, regions, layers, and/or parts. However, these elements, components, regions, layers, and/or parts should not be limited by these terms. These terms are only used to distinguish one element, component, region, layer, or part from another element, component, region, layer, or layer. Therefore, a first element, component, region, layer, or part discussed below can also be referred to as a second element, component, region, layer, or part, which does not constitute a departure from the teachings of the present disclosure.

A term specifying a relative spatial relationship, such as “below,” “beneath,” “lower,” “under,” “above,” or “higher,” can be used in the disclosure to describe the relationship of one or more elements or features relative to other one or more elements or features as illustrated in the drawings. These relative spatial terms are intended to also encompass different orientations of the device in use or operation in addition to the orientation shown in the drawings. For example, if the device in a drawing is turned over, an element described as “beneath,” “below,” or “under” another element or feature would then be “above” the other element or feature. Therefore, an example term such as “beneath” or “under” can encompass both above and below. Further, a term such as “before,” “in front of,” “after,” or “subsequently” can similarly be used, for example, to indicate the order in which light passes through the elements. A device can be oriented otherwise (e.g., being rotated by 90 degrees or being at another orientation) while the relative spatial terms used herein still apply. In addition, when a layer is referred to as being “between” two layers, it can be the only layer between the two layers, or there can be one or more intervening layers.

Terminology used in the disclosure is for the purpose of describing the embodiments only and is not intended to limit the present disclosure. As used herein, the terms “a,” “an,” and “the” in the singular form are intended to also include the plural form, unless the context clearly indicates otherwise. Terms such as “comprising” and/or “including” specify the presence of stated features, entities, steps, operations, elements, and/or parts, but do not exclude the existence or addition of one or more other features, integers, steps, operations, elements, parts, and/or combinations thereof. As used herein, the term “and/or” includes any and all combinations of one or more of the listed items. The phrases “at least one of A and B” and “at least one of A or B” mean only A, only B, or both A and B.

When an element or layer is referred to as being “on,” “connected to,” “coupled to,” or “adjacent to” another element or layer, the element or layer can be directly on, directly connected to, directly coupled to, or directly adjacent to the other element or layer, or there can be one or more intervening elements or layers. In contrast, when an element or layer is referred to as being “directly on,” “directly connected to,” “directly coupled to,” or “directly adjacent to” another element or layer, then there is no intervening element or layer. “On” or “directly on” should not be interpreted as requiring that one layer completely covers the underlying layer.

In the disclosure, description is made with reference to schematic illustrations of example embodiments (and intermediate structures). As such, changes of the illustrated shapes, for example, as a result of fabrication techniques and/or tolerances, can be expected. Thus, embodiments of the present disclosure should not be interpreted as being limited to the specific shapes of regions illustrated in the drawings, but are to include deviations in shapes that result, for example, from fabrication. Therefore, the regions illustrated in the drawings are schematic and their shapes are not intended to illustrate the actual shapes of the regions of the device and are not intended to limit the scope of the present disclosure.

Unless otherwise defined, all terms (including technical and scientific terms) used herein have the same meaning as commonly understood by those of ordinary skill in the art to which this disclosure belongs. Terms such as those defined in commonly used dictionaries should be interpreted to have meanings consistent with their meanings in the relevant field and/or in the context of this disclosure, unless expressly defined otherwise herein.

As used herein, the term “substrate” can refer to the substrate of a diced wafer, or the substrate of an un-diced wafer. Similarly, the terms “chip” and “die” can be used interchangeably, unless such interchange would cause conflict. The term “layer” can include a thin film, and should not be interpreted to indicate a vertical or horizontal thickness, unless otherwise specified.

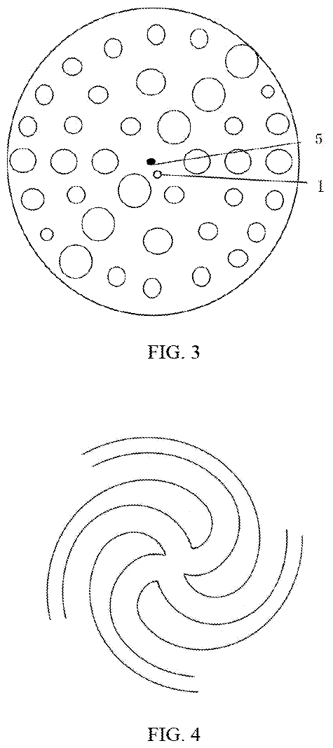

FIG. 1 is a schematic structural diagram of an exemplary symmetrical metasurface optical device according to some embodiments of the present disclosure. FIG. 2 is a schematic cross-sectional view of an exemplary metasurface structure according to some embodiments of the present disclosure. FIG. 3 is a schematic diagram showing a periodic arrangement and distribution of nanopillars in polar coordinates according to some embodiments of the present disclosure. FIG. 4 is a schematic diagram of a vortex distribution of nanopillars according to some embodiments of the present disclosure.

As shown in FIG. 1, FIG. 2, FIG. 3, and FIG. 4, the present disclosure provides a symmetrical metasurface optical device. The symmetrical metasurface optical device includes a substrate 3 and a plurality of nanopillars 4 symmetrically arranged at a surface of the substrate 3. The plurality of nanopillars 4 may have different optical properties. A center of symmetry of the plurality of nanopillars refers to a center of symmetry of a nanopillar structure region. A center 1 of the substrate 3 is a center of the symmetrical metasurface optical device. When the center of symmetry of the nanopillar structure region coincides with the center 1 of the substrate, nanopillars of a same optical property among the plurality of nanopillars 4 are distributed non-uniformly and symmetrically. Alternatively, when the nanopillars of the same optical property among the plurality of nanopillars 4 are distributed uniformly and symmetrically, the center of symmetry of the nanopillar structure region does not coincide with the center 1 of the substrate.

In some embodiments, a material of the substrate 3 is often a wafer, but the material of the substrate 3 may not be limited to the wafer, and may also be other materials. The plurality of nanopillars may be arranged at the surface of the substrate according to a preset rule or pattern. Because a difference in the optical properties of the nanopillars mainly depends on a shape and material of the nanopillars, different materials, positions, shapes, periods, arrangements, and heights of the nanopillars may achieve arrangement effects of the plurality of nanopillars with non-uniform and symmetrical distribution or uniform and symmetrical distribution.

The symmetrical metasurface optical device provided by the embodiments of the present disclosure includes the substrate and the plurality of nanopillars symmetrically arranged at the surface of the substrate. The nanopillars are arranged at the substrate according to the preset rule. The incident light may be coupled into the symmetrical metasurface optical device. The symmetrical metasurface optical device may be used as an asymmetrical optical waveguide to change the optical property in a direction perpendicular to an axial direction of the symmetrical metasurface optical device, thereby eliminating asymmetrical aberrations.

In some embodiments, when the nanopillars of the same optical property among the plurality of nanopillars 4 are uniformly and symmetrically arranged, the center of symmetry of the plurality of nanopillars 4 not coinciding with the center of the substrate 3 may include the plurality of nanopillar being arranged in at least two symmetrical regions, where each of the at least two symmetrical regions includes a center of symmetry.

In some embodiments, the nanopillars of the same optical property among the plurality of nanopillars 4 are uniformly and symmetrically arranged, and the center of symmetry of the nanopillar structure area not coinciding with the center 1 of the substrate includes a first situation, in which the nanopillars are arranged in two symmetrical regions through their different materials, positions, shapes, periods, arrangements, heights, etc. Each symmetrical region has a center of symmetry. At least one of the two centers of symmetry does not coincide with the center of the substrate. The number of the symmetrical regions where the plurality of nanopillars are arranged at the surface of the substrate may not be 2, or may be greater than 2. At least one of the centers of symmetry does not coincide with the center 1 of the substrate.

In some embodiments, when the nanopillars of the same optical property among the plurality of nanopillars are arranged uniformly and symmetrically, the center of symmetry of the plurality of nanopillars 4 not coinciding with the center of the substrate may include the nanopillars of same optical properties being periodically arranged at the surface of the substrate 3 based on polar coordinates. An origin 5 of the polar coordinates is the center of symmetry of an arrangement structure of the plurality of nanopillars. The periodic arrangement refers to an arrangement according to a preset arrangement rule. The preset arrangement rule may include, for each region of nanopillars, a number of nanopillars of the same optical property, positions of nanopillars of different optical properties, and a distance between adjacent nanopillars.

In some embodiments, when the nanopillars of the same optical property among the plurality of nanopillars 4 are uniformly and symmetrically arranged, the center of symmetry of a nanopillar structure region not coinciding with the center 1 of the substrate includes a second situation, in which the number of the nanopillars, the position of nanopillars of different optical properties, and the distance between adjacent nanopillars are calculated, such that the plurality of nanopillars are arranged periodically in the polar coordinates, as shown in FIG. 3. The origin 5 of the polar coordinates, that is, the center of symmetry of the arrangement structure of the plurality of nanopillars does not coincide with the center 1 of the substrate.

In some embodiments, when the nanopillars of the same optical property among the plurality of nanopillars are uniformly and symmetrically arranged, the center of symmetry of the plurality of nanopillars not coinciding with the center of the substrate includes: the plurality of nanopillars being periodically arranged at the surface of the substrate in mutually perpendicular rows and columns.

In some embodiments, when the nanopillars of the same optical property among the plurality of nanopillars 4 are uniformly and symmetrically arranged, the center of symmetry of the nanopillar structure region not coinciding with the center 1 of the substrate includes a third situation, in which the number of the nanopillars, the positions of nanopillars of different optical properties, and the distance between adjacent nanopillars are calculated, such that the plurality of nanopillars are arranged at the surface of the substrate in the mutually perpendicular rows and columns.

When the nanopillars of the same optical property among the plurality of nanopillars 4 are uniformly and symmetrically arranged, the center of symmetry of the nanopillar structure region not coinciding with the center 1 of the substrate may not be limited to the above three situations, and other situations may also be applicable.

In some embodiments, a cross-sectional shape of any nanopillar of the plurality of nanopillars includes any of the following: a circle, a square, a star, a ring, a pentagon, and a hexagon.

In some embodiments, the cross-sectional shape of any pillar of the plurality of nano-pillars may be circular, square, and star-shaped. The shape of the nanopillars may not be limited to the above-described shapes, and other shapes may also be applicable.

In some embodiments, the plurality of nanopillars may include at least two types of materials. The two types of materials differ from each other in at least one of a dispersion coefficient, a refractive index, or an absorption coefficient.

In some embodiments, the plurality of nanopillars include one or more first nanopillars made of a same material, and one or more second nanopillars made of a material different from the material of the first nanopillars.

In some embodiments, there are two types of materials for the plurality of nanopillars. The dispersion coefficient, the refractive index, and the absorption coefficient of these two types of materials are all different. The number of the one or more first nanopillars can depend on the function of the metasurface optical device. Each nanopillar in the first nanopillars is made of the same material. The material of any nanopillar in the second nanopillars is different from that of the first nanopillars. Of course, there may be more than two types of materials for the nanopillars. At least two of the materials of the nanopillars have different optical properties, and the optical properties are different as long as at least one parameter such as the dispersion coefficient, the refractive index, and the absorption coefficient is different.

In some embodiments, when the center of symmetry of the plurality of nanopillars 4 coincides with the center 1 of the substrate, the non-uniform and symmetrical arrangement of the nanopillars of the same optical property among the plurality of nanopillars includes: the nanopillars of the same optical property among the plurality of nanopillars being arranged in a vortex symmetry with reference to the center of symmetry, and the nanopillars of different optical properties among the plurality of nanopillars being arranged adjacent to each other in the vortex symmetry structure.

In some embodiments, the center of symmetry of the nanopillar structure region coincides with the center 1 of the substrate. The non-uniform and symmetrical arrangement of the nanopillars of the same optical property among the plurality of the nanopillars 4 may include: the non-uniform distribution in the vortex symmetry as shown in FIG. 4. The nanopillars of the same optical property are arranged in the vortex symmetry, and the nanopillars of different optical properties are arranged adjacent to each other in the vortex symmetry structure. The center of the vortex symmetry coincides with the center 1 of the substrate.

Further, in the symmetrical metasurface optical device with the structure described in the embodiments of the present disclosure, the plurality of nanopillars are arranged at the surface of the substrate of the symmetrical metasurface optical device according to the preset rule. The incident light may be coupled into the symmetrical metasurface optical device. At the same time, the symmetrical metasurface optical device functions as the asymmetrical optical waveguide to change the optical property of the symmetric metasurface optical device in the direction perpendicular to the axis, thereby eliminating the asymmetrical aberrations.

While various embodiments of the present disclosure have been described, additional changes and modifications to these embodiments may be made by those skilled in the art once the basic inventive concept is appreciated. Therefore, the appended claims are intended to be construed to cover some embodiments and all changes and modifications which fall within the scope of the present disclosure.

The specific implementation manners described above have further described the purpose, technical solutions, and beneficial effects of the application in detail. The above descriptions are merely intended to be exemplary and are not intended to limit the scope of the present disclosure. Any modification, equivalent replacement, improvement, etc. made on the basis of the technical solution of the present disclosure shall be included in the scope of the present disclosure.

What is claimed is:

1. A symmetrical metasurface optical device comprising:
a substrate; and
a plurality of nanopillars symmetrically arranged at a surface of the substrate, the plurality of nanopillars having different optical properties;
wherein:
a center of symmetry of the plurality of nanopillars coincides with a center of the substrate, and nanopillars of a same optical property among the plurality of nanopillars are distributed non-uniformly and symmetrically; or
the nanopillars of the same optical property among the plurality of nanopillars are distributed uniformly and symmetrically, and the center of symmetry of the plurality of nanopillars does not coincide with the center of the substrate.

2. The symmetrical metasurface optical device of claim 1, wherein:
the plurality of nanopillar are arranged in at least two symmetrical regions, each of the at least two symmetrical regions including a center of symmetry.

3. The symmetrical metasurface optical device of claim 1, wherein:
the nanopillars of the same optical property among the plurality of nanopillars are periodically arranged at the surface of the substrate based on polar coordinates, an origin of the polar coordinates being a center of symmetry of an arrangement structure of the plurality of nanopillars; and
the nanopillars of the same optical property are arranged according to a preset arrangement rule, and the preset arrangement rule includes, for each region of nanopillars, a number of nanopillars of the same optical property, positions of nanopillars of different optical properties, and a distance between adjacent nanopillars.

4. The symmetrical metasurface optical device of claim 1, wherein:
the plurality of nanopillars are periodically arranged at the surface of the substrate in mutually perpendicular rows and columns.

5. The symmetrical metasurface optical device of claim 1, wherein:
a cross-sectional shape of any nanopillar of the plurality of nanopillars includes any of a circle, a square, a star, a ring, a pentagon, a cross shape, and a hexagon.

6. The symmetrical metasurface optical device of claim 1, wherein:
the plurality of nanopillars include at least two types of materials that differ from each other in at least one of a dispersion coefficient, a refractive index, or an absorption coefficient.

7. The symmetrical metasurface optical device of claim 6, wherein:
the plurality of nanopillars include one or more first nanopillars made of a first material, and one or more second nanopillars made of a second material different from the first material.

8. The symmetrical metasurface optical device of claim 1, wherein:
the nanopillars of the same optical property among the plurality of nanopillars are arranged in a vortex symmetry with reference to a center of symmetry to form a vortex symmetry structure, and nanopillars of different optical properties among the plurality of nanopillars are arranged adjacent to each other in the vortex symmetry structure.
